(19) United States
(12) Patent Application Publication
(10) Pub. No.: US 2026/0130365 A1
(43) Pub. Date: May 14, 2026

(54) BIOCIDAL COMPOSITION

(71) Applicant: 3M INNOVATIVE PROPERTIES COMPANY, St. Paul, MN (US)

(72) Inventors: Mark V. Riofski, Eagan, MN (US); Manjiri Kshirsagar, Woodbury, MN (US); Petra L. Kohler Riedi, Minneapolis, MN (US); Richard J. Pokorny, Maplewood, MN (US)

(21) Appl. No.: 19/118,622

(22) PCT Filed: Sep. 7, 2023
(86) PCT No.: PCT/IB2023/058881

§ 371 Date: Apr. 4, 2025

Related U.S. Application Data
(60) Provisional application No. 63/378,750, filed on Oct. 7, 2022.

(51) Int. Cl. A01N 25/30; A01N 25/10; A01N 37/02; A01N 37/04; A01P 1/00

(52) U.S. Cl. CPC A01N 25/30; A01N 25/10; A01N 37/02; A01N 37/04; A01P 1/00

(57) ABSTRACT

The present invention is a disinfecting composition includes a glucosamine-based saccharide polymer, a carboxylic acid, an amino acid-based cationic surfactant, and a non-ionic surfactant. The disinfecting composition includes a carboxylic acid to glucosamine-based saccharide polymer ratio of at least about 1. A viscosity of the glucosamine-based saccharide polymer is less than about 50 cps. Upon drying, the disinfecting composition forms a substantially clear and non-tacky film.

### FIELD OF THE INVENTION

The present invention relates generally to the field of disinfecting compositions. In particular, the present invention is a clear, non-tacky disinfecting composition.

### BACKGROUND

Historically, the primary method of delivering antimicrobial performance has been to provide a formulation, or method, that immediately kills upon contact with the surface substrate. These methods include using quaternary ammonium salts, hydrogen peroxide, bleach, UV light, or metal-based salts/particles such as copper or silver. Regardless of the mechanism of inducing killing of the microbial matter, there has been limited investment in providing a solution for a residual performance beyond the established contact time.

In recent years, there has been a significant increase in the demand for antimicrobial products, along with the desire for improved longer lasting performance. Currently in the market, there are a few known methods to employ a residual antimicrobial. One method utilizes a quaternary ammonium silane such as dimethyloctadecyl[3-(trimethoxysilyl)propyl]ammonium chloride or its trihydroxypropyl derivative. Historically, quat silane is used to inhibit the growth of mold on substrates, such as bathroom tiles. The trimethoxy or trihydroxy portion of the molecule can provide anchoring to the substrate such that it remains adhered to the substrate for up to greater than 90 days. The role of the trimethoxy or trihydroxy portion of the molecule in providing efficacious performance beyond mold inhibition has started to be investigated in various areas; however, the efficacy thus far has been broad in reproducibility and narrow in its specific target of microbes (See for example, US20180242585). Also, application of the quat silane can be tedious, first requiring a tie anchoring layer deposited before antimicrobial application.

A second method involves using nano-copper or nano-silver particles. These are often embedded into a resin substrate, such as a non-woven, knit or woven fabric.

Finally, from a consumer usage perspective, a formulation including polyoxazolidine is used as a binder for a biocidal package that includes a typical quaternary ammonium salt offering of Alkyl* dimethyl benzyl ammonium chloride *(50% C14, 40% C12, 10% C16), 1-Decanaminium, N,N-dimethyl-N-octyl-, chloride, 1-Decanaminium, N-decyl-N,N-dimethyl-, chloride, 1-Octanaminium, N,N-dimethyl-N-octyl-, chloride. Products within the family also can contain citric acid, which is additionally a known pesticide, for microbial treatments. When in liquid form, the formulation allows for contact time and acts as a contact disinfectant. If allowed to dry without wiping, the formulation can provide continued bacterial protection for up to 24 hours. However, there are issues with the use of this formulation. The oxazoline is often used as an adhesive and therefore, the resulting film binder material has a tacky feel. Additionally, the formulation used as a biocide package is not food contact safe. Thus, should this product be used on a countertop or kitchen table, the product can only be used as a contact disinfectant and not for its residual performance. If used in an area that may come into contact with food, the proper procedure would be to cleanse the treated area completely with water, negating the value of 24-hour performance.

### SUMMARY

In one embodiment, the present invention is a disinfecting composition that includes a glucosamine-based saccharide polymer, a carboxylic acid, an amino acid-based cationic surfactant, and a non-ionic surfactant. The disinfecting composition includes a carboxylic acid to glucosamine-based saccharide polymer ratio of at least about 1. A viscosity of the glucosamine-based saccharide polymer is less than about 50 centipoise (cps). Upon drying, the disinfecting composition forms a substantially clear and non-tacky film.

### DETAILED DESCRIPTION

The present invention is a clear, non-tacky disinfecting composition that provides biocidal activity upon contact with a surface as well as residual biocidal activity after contact. This allows the disinfecting composition to clean, coat, and protect a surface in both a wet and dry state. In one embodiment, once the disinfecting composition dries, it forms a residual film that can continue to kill bacteria for up to an additional 24 hours. The disinfecting composition generally includes a glucosamine-based saccharide polymer, a carboxylic acid, an amino acid-based cationic surfactant, and a non-ionic surfactant. The disinfecting composition is sustainable and provides a food contact safe solution that maintains residual antimicrobial performance.

The glucosamine-based saccharide polymer functions as a binder and adjuvant for the carboxylic acid. In one embodiment, the glucosamine-based saccharide polymer is a biopolymer derived from the natural material chitosan. Chitosan is included in the United States Environmental Protection Agency's (EPA) list of active ingredients eligible for EPA's minimum risk pesticide exemption under Federal Insecticide, Fungicide, and Rodenticide Act (FIFRA) Section 25(b), making chitosan suitable for use in both food and non-food contact applications. An example of a suitable chitosan includes, but is not limited to, D-glucosamine and N-acetyl-D-glucosamine linked by B-(1-4) glycosidic linkages. In one embodiment, the viscosity of the glucosamine-based saccharide polymer is less than about 50 centipoise (cps), particularly less than about 30 cps, and more particularly less than about 25 cps. The viscosity of the glucosamine-based saccharide polymer can depend on a number of factors, including for example, the molecular weight and ratio of glucosamine-based saccharide polymer to carboxylic acid. Another factor affecting the solubility, and relatedly, viscosity, of a compound or composition is by measuring the deacetylation value. Generally, the higher the deacetylation value, the more soluble the compound or composition. In one embodiment, the glucosamine-based saccharide polymer has a deacetylation value above about 80% and particularly above about 85%. In one embodiment, the glucosamine-based saccharide polymer has a concentration of between about 1.5 wt % and about 3 wt % and particularly of at least about 1.5 wt % based upon total weight percentage of the composition.

The glucosamine-based saccharide polymer is generally in the form of a solid, such as flakes or ground powder, and is water insoluble. To incorporate the glucosamine-based saccharide polymer into a water system, a carboxylic acid functions as a solvating acid to make the glucosamine-based saccharide polymer water soluble. Examples of suitable carboxylic acids include, but are not limited to: acetic oxalic, lactic, citric, butyric, and octanoic acid. Examples of particularly suitable carboxylic acids include lactic and citric acid. In one embodiment, the disinfecting composition includes about equal parts glucosamine-based saccharide polymer and carboxylic acid. In one embodiment, the disinfecting composition includes a carboxylic acid to glucosamine-based saccharide polymer ratio of at least about 1. If the amount of carboxylic acid is higher than the amount of glucosamine-based saccharide polymer, the resulting coating will be sticky or opaque. In one embodiment, the carboxylic acid has a concentration of between about 1.5 wt % and about 3 wt % and particularly of at least about 1.5 wt % based upon total weight percentage of the composition.

The disinfecting composition of the present invention also includes an amino acid-based cationic surfactant. In one embodiment, the amino acid-based cationic surfactant is made with L-arginine. The amino-acid cationic surfactant can also be broadly classified as a guanidine-type surfactant or guanidine end surfactant. An example of a particularly suitable amino acid-based cationic surfactant is ethyl lauryl arginate. Commercially available cationic surfactant is Ethyl Lauryl Arginate from AA Blocks Inc (San Diego, CA, United States). In one embodiment, the amino acid-based cationic surfactant has a concentration of between about 0.2 wt % and about 1.0 wt % and particularly of at least about 0.6 wt % based upon total weight percentage of the composition.

A non-ionic surfactant is also added to the disinfecting composition to improve cleaning application and wetting of the surface substrate. The non-ionic surfactant can also help with leveling of the disinfecting composition. In one embodiment, the non-ionic surfactant is food contact safe. An example of a suitable non-ionic surfactant includes, but is not limited to, a glucoside. Commercially available non-ionic surfactants include PLANTERAN 810P and GLUCOPON 425N from BASF Corporation (Florham Park, NJ, United States) and glycerol. In one embodiment, the non-ionic surfactant has a concentration of between about 0.5 wt % and about 5 wt % and particularly of at least about 1 wt % based upon total weight percentage of the composition. The non-ionic surfactant material is 62% solids resulting in a modification to the weight percent based on the total composition to be 0.3 wt % to 3.1 wt %.

The glucosamine-based saccharide polymer, a carboxylic acid, an amino acid-based cationic surfactant, and a non-ionic surfactant are added to water to create the disinfecting composition. In one embodiment, the water has a concentration of between about 88 wt % and about 96.3 wt % and particularly of at least about 89 wt % based upon total weight percentage of the composition.

The disinfecting composition of the present invention has the ability to kill gram-positive bacteria and gram-negative bacteria. Generally, gram-positive bacteria are monoderms and have a single lipid bilayer while gram negative bacteria are diderms and have two bilayers. Gram-positive bacteria include, for example, Streptococci and Staphylococci. Gram-negative bacteria include, for example, Pseudomonas aeruginosa and Klebsiella pneumoniae. The disinfecting composition can kill gram-positive and gram-negative bacteria in either a wet or dry state. The ability of a composition to kill bacteria can be measured by the log reduction value. A log reduction value of about 3 and above indicates that the composition is effective at killing bacteria. A log reduction value of about 5 and above indicates that the composition is effective at killing bacteria and disinfecting the contact surface. In one embodiment, the disinfecting composition has a wet log reduction value of up to about 6. In one embodiment, the disinfecting composition has a dry log reduction value of between about 3 and about 6. The disinfecting composition can be modified depending on the desired results. For example, both lactic acid and citric acid are effective at performing against gram positive and negative bacteria in both the wet and dry states while acetic acid does not perform as well as a dry coating against gram-positive bacteria.

To maintain a homogeneous solution, the pH of the disinfecting composition must be maintained under a certain level in order to solvate the glucosamine-based saccharide polymer into water. In one embodiment, the pH of the disinfecting composition is less than about 6, particularly less than about 5, and more particularly less than about 4. The glucosamine-based saccharide polymer will protonate into an organic salt with the carboxylic acid, allowing water solvation. Maintaining an even lower pH allows for greater salt formation and therefore greater solvation. This is related to the deacetylation percentage; for every point of deacetylation there is a point of acid protonation and therefore greater solvation into the water. When the solution is homogeneous, the disinfecting composition will wet the contact surface substrate more uniformly when sprayed.

In one embodiment, the disinfecting composition is visually clear and non-visible to the eye upon application. Upon drying, the disinfecting composition of the present invention forms a substantially clear film.

The disinfecting composition of the present invention forms a non-tacky film. That is, after drying, the disinfecting composition does not feel sticky to the touch.

The disinfecting composition is also wear-resistant. Upon drying, the coating clarity of the disinfecting composition is not substantially affected after being subjected to wear-resistance testing. In addition, after being subjected to inoculation testing, the antimicrobial properties of the disinfecting composition were also substantially not affected. In one embodiment, the disinfecting composition continues to kill bacteria for at least about 24 hours after application of the disinfecting composition, particularly for at least about 48 hours after application, and more particularly for at least about 72 hours after application.

Through shearing, the viscosity of the disinfecting solution can be tuned to allow for excellent coating capability of the composition either through, for example, metered coating applications or spray applications. The viscosity of the disinfecting solution is influenced by factors such as choice of carboxylic acid, temperature of mixing, shear of blade stirring, amount of time, and chemical additives such as hydrogen peroxide. In one embodiment, the disinfecting composition has a viscosity of about 50 centipoise (cps) or less and particularly of about 25 cps or less. This provides a viscosity that can easily be dispensed from a common trigger spray system. In addition, this provides the ability for the disinfecting composition to be applied to food contact surfaces.

### EXAMPLES

Objects and advantages of this disclosure are further illustrated by the following non-limiting examples, but the materials and amounts thereof recited in these examples, as well as other conditions and details, should not be construed to unduly limit this disclosure. Unless otherwise noted, all parts, percentages, ratios, etc. in the Examples and the rest of the specification are by weight percent. Where applicable, brand names and trademarked names are shown in all caps.

TABLE 1
Materials List

| Material | Description | Source |
|---|---|---|
| CHIT1 | Chitosan, low molecular weight, | Dungeness Environmental |
| | 35 cps, available under the trade | Solutions, Inc. |
| | designation CHITOVAN CF | (DESI), Bothell, |
| | | WA, United States |
| CHIT2 | Fungal chitosan | Shaanxi Biotech Co., |
| | | Ltd., Hanzhong |
| | | City, China |
| LA | Lactic Acid | Sigma-Aldrich, |
| | | St. Louis, MO, |
| | | United States |
| NIS-1 | Nonionic Surfactant-1, | BASF Corporation, |
| | commercially available under | Florham Park, NJ, |
| | the designation | United States |
| | PLANTERAN 810P | |
| NIS-2 | Nonionic Surfactant-2, | BASF Corporation |
| | commercially available under | |
| | the trade designation | |
| | GLUCOPON 425N | |
| HUM | Humectant, available as | Alfa Aesar, Ward |
| | glycerol | Hill, MA, |
| | | United States |
| CS-1 | Cationic Surfactant-1, amino | AA Blocks Inc, |
| | acid-based available as | San Diego, CA, |
| | Ethyl Lauryl Arginate | United States |
| CS-2 | Cationic Surfactant-2, quaternary | Stepan Company, |
| | available under the trade | Northbrook, IL, |
| | designation BTC 25M-SC | United States |
| CS-3 | Cationic Surfactant-3, quaternary | Stepan Company |
| | available under the trade | |
| | designation BTC 2125M | |
| CS-4 | Cationic Surfactant-4, quaternary | Stepan Company |
| | available under the trade | |
| | designation BTC 1210-80 | |
| AD-1 | Additive-1, available under | Sigma-Aldrich |
| | the designation ammonium | |
| | citrate dibasic | |
| AD-2 | Additive-2, available under | Sigma-Aldrich |
| | the designation sodium | |
| | citrate monobasic | |
| AD-3 | Additive-3, available under the | Sigma-Aldrich |
| | designation sodium benzoate | |
| MB24 | Microban 24 | W.M. Barr, Memphis, |
| | | TN, United States |

### Test Methods

### Tack Test:

Sample coatings were applied using a Meyer bar (420) to a 15.24 cm×15.24 cm (6 inch×6 inch) stainless-steel substrate and allowed to dry completely (24 hours). A Texture Analyzer FD with a TA-57R 7 mm-1″R model tip was used to measure the tackiness of the sample. Testing was performed using 50.0 g compression force. Other analyzer settings were as follows: pre-test speed: 10 mm/sec, compression start test speed: 0.05 mm/sec, retreat speed: 0.5 mm/sec, post-test speed: 15.0 mm/sec, compression hold time: 10.1 seconds, trigger force: 1.0 g and retreat position: 5.0 mm). Each sample was tested three times. Values at or near 0 are defined as having little to no tack.

### Haze Test:

Sample coatings were applied using a Meyer bar (#20) to a 7.62 cm×10.2 cm (3 inch×4 inch) glass coupon and allowed to dry completely (24 hours). A haze-gard plus instrument (obtained from BYK-Gardner, Columbia, MD) was used to measure haze according to the ASTM D1003 test standard. Each sample was tested three times. Values at or near 0 are defined as having little to no haze.

### Antimicrobial Test:

TABLE 2
Antimicrobial Test Materials

| Material | Description | Source |
|---|---|---|
| Bacterial | Staphylococcus aureus | The American |
| cultures | (S. aureus) | Type Culture |
| | ATCC 6538 | Collection |
| | Klebsiella pneumoniae | (ATCC), |
| | (K. pneumoniae) | Manassas, VA, |
| | ATCC 4352 | United States |
| TSA | Tryptic Soy Agar plates | Hardy |
| | | Diagnostics, Santa |
| | | Maria, CA, United |
| | | States |
| Nutrient | BD DIFCO Nutrient Broth prepared | Thermo Fisher |
| Broth | according to manufacturer's | Scientific, |
| | instructions | Waltham, MA, |
| | | United States |
| BBL | Mini Flip-Top Vial with 9 mL | 3M Company, St. |
| | Butterfield's Buffer | Paul, MN, United |
| | | States |
| FBS | GIBCO Heat Inactivated Fetal | Thermo Fisher |
| | Bovine Serum | Scientific |
| PAC plate | PETRIFILM Aerobic Count Plate | 3M Company |
| Letheen | BD DIFCO Letheen Broth prepared | Thermo Fisher |
| Broth | according to manufacturer's | Scientific |
| | instructions | |

### Test Organisms for Antimicrobial Efficacy Test

Cultures of Staphylococcus aureus (S. aureus ATCC 6538), and Klebsiella pneumoniae (K. pneumoniae ATCC 4352) were maintained on TSA plates. The initial inoculum was prepared by suspending a bacterial colony from TSA plates into a tube containing 10 mL of Difco Nutrient Broth and incubating at 37° C. in a shaker incubator (Innova 44, New Brunswick Scientific) for 20-24 hours. The cell density in the overnight cultures was approximately 1.0×10⁹ colony forming units/mL (CFU/mL) for Staphylococcus aureus, and 1.0×10¹⁰ CFU/mL for Klebsiella pneumoniae. This antimicrobial efficacy test consisted of the following steps: spraying test surfaces with test formulations, performing an initial sanitizer test, re-inoculating test surfaces five times, with wear cycles between two reinoculation cycles.

### Preparation of Test Surface

Stainless steel coupons (0.08 cm×2.54 cm×2.54 cm (0.030 inch×1 inch×1 inch), McMaster-Carr, T-304 Stainless Steel, #8 Mirror w/ PVC) were cleaned using 70% Isopropanol or 70% Ethanol and allowed to air dry for ten minutes on test tube stands.

### Application of Test Formulation

A sample was applied using an OpUs-SOS spray trigger with two sprays (using mist setting) from 15.24 cm (6 inches) and set to dry for three hours.

### Sanitizer Test

Test organisms and test surfaces were prepared as described above. A test culture with a cell density of approximately 1.0×10⁹ CFU/mL was used for the sanitizer test. The overnight culture of K. pneumoniae was diluted 1:10 in Butterfield's Buffer (BBL). Fetal Bovine Serum (FBS) was added to the test culture at 5% organic soil load. The test surfaces were then inoculated with 10 μL of the test culture and spread using the tip of the micropipette tip. The test surfaces were kept at room temperature (about 22° C.) for a contact time of five minutes. Using sterile forceps, the test surfaces were then transferred to 50 ml sterile polypropylene tubes containing 30 mL of Neutralization broth (Letheen broth). The tubes were then sonicated for 20 seconds (at 60 Hz using Branson 2510 MTH,) and agitated on a vortex mixer (Fisher Scientific Multitube Vortexer) at 750 rpm for one minute. The solution was serially diluted 1:10, four times, using 9 mL BBL. From each dilution, 1 mL was plated onto PAC plates. The PAC plates were incubated overnight at 37° C. for 22-24 hours. The colony counts (CFUs) on each plate were enumerated using PETRIFILM Plate Reader (3M Company, St. Paul, MN). The log reduction was calculated by the multiplying the colony count by the dilution factor, converting it to log base 10 value and then subtracting from the corresponding log value from counts from the control plates. Control plate counts were obtained from untreated (without formulation) test substrates inoculated alongside test formulations and processed exactly as described in the steps above.

$$Log Reduction Value = log ( {CFU}_{control} ) - log ( {CFU}_{test} )$$

Unless noted otherwise, test formulations were tested in triplicates.

### Reinoculations Test

Test organisms and surfaces were prepared as described above. The cell cultures were serially diluted in BBL to a density of approximately 1.0×10⁵ CFU/mL with 5% FBS organic soil load. An initial inoculation of 10 μL of the test culture was spread onto the test surface and air dried for 30 minutes. The test formulation was then applied to the surface as described above.

After the initial inoculation and application of the test formulation, five reinoculations were completed on each test surface. These were completed using cell cultures diluted to a density of approximately 1.0×10⁵ CFU/mL in BBL with 5% FBS. A 10 μL volume of the initial inoculum was spread onto the test surface using the tip of the pipette and allowed to dry for 30 minutes. Once five reinoculations were completed and dried, a Sanitizer Test was run as described above.

### Wear and Reinoculations

Test organisms and surfaces were prepared as described above. The cell cultures were diluted to a density of approximately 1.0×10⁵ CFU/mL in BBL with 5% FBS. An initial inoculation of 10 μL of the test culture was spread onto the test surface and let dry for 30 minutes. The test formulation was then applied to the steel surfaces as described above.

In this test, reinoculations as described above were alternated with wear cycles. The wear cycles were completed using an abrasion tester (GardCo® Washability and Wear Tester, Model D10V purchased from Gardco, Pompano Beach, FL) fitted with 2-inch strips of ⅛-inch polyurethane foam (FoamWipe wiper, purchased from VWR), at a speed of 13.5 to 15 rpm for a complete cycle time of 4-5 seconds. A cycle consisted of one pass to the left and one to the right. Dry and wet wear cycles are alternated. For the dry cycles, a dry cotton cloth (TexWipe, TX309 purchased from VWR) is attached to the abrasion boat. For the wet cycles, the cloth is attached to the abrasion boat, and is then sprayed with distilled water (building supply) using a Preval® sprayer from a distance of 75 cm for up to 3 seconds.

After alternating reinoculations and wear cycles for a total of five reinoculations and twelve total wear cycles, a sanitizer test was completed as described above.

### Wet Testing

Test organisms were diluted in Butterfield's Buffer (BBL) to a cell density of approximately 1.0×10⁶ CFU/mL. Fetal Bovine Serum (FBS) was added to the test culture at 5% organic soil load. Testing was conducted in a 1.5 mL sterile test tubes obtained from Eppendorf, Hamburg, Germany. 100 μL of a sample composition was added to the Eppendorf tube. Next, 100 μL of the test culture was added and the tube was mixed at 2500 revolutions per minute (RPM) on a vortex mixer (Fisher Scientific Multitube Vortexer) for 10 seconds. The tubes sat for a contact time of 5 minutes. Then, 800 μL of Neutralization broth (Letheen broth) was added to the tubes and agitated on the vortex mixer at 2500 RPM of 10 seconds. From each tube, 1 mL was plated onto PAC plates. The PAC plates were incubated overnight at 37° C. for 22-24 hours. The colony counts (CFUs) on each plate were enumerated using a PETRIFILM Plate Reader. Log reduction was calculated by the multiplying the colony count by the dilution factor, converting it to log base 10 value and then subtracting from the corresponding log value from counts from the control plates. Control plate counts were obtained from test cultures (without formulation) processed alongside test formulations exactly as described in the steps above. Unless noted otherwise, test formulations were tested in triplicates.

$$Log Reduction Value = log ( {CFU}_{control} ) - log ( {CFU}_{test} )$$

### Residual Self-Sanitization (Wear) Test

Methods identified in US EPA Protocol #01-1A were followed.

### Examples 1-18 (EX1-EX18) and Comparative Examples 1-10 (CE1-CE10)

Quantities of CHIT, LA, and water (in weight percent) identified in Table 3, were combined, heated to 100° C., and vigorously stirred for three hours to create stock solutions and allowed to cool to ambient temperature. Other materials (in weight percent) identified in Table 3 were then added to the stock solution, until they were well combined and mixed for up to ten minutes. Tack and Haze testing were conducted on specific examples and comparative examples, and the results are represented in Table 4.

TABLE 3
Disinfecting Compositions (weight percent)

| | CHIT1 | CHIT2 | LA | H₂O | NIS-1 | NIS-2 | HUM | CS-1 | CS-2 | CS-3 | CS-4 | AD-1 | AD-2 | AD-3 |
|---|---|---|---|---|---|---|---|---|---|---|---|---|---|---|
| EX1 | 2.5 | 0 | 2.5 | 93.7 | 1.0 | 0 | 0 | 0.3 | 0 | 0 | 0 | 0 | 0 | 0 |
| EX2 | 2.5 | 0 | 2.5 | 89.7 | 5.0 | 0 | 0 | 0.3 | 0 | 0 | 0 | 0 | 0 | 0 |
| EX3 | 2.5 | 0 | 2.5 | 89.4 | 5.0 | 0 | 0 | 0.6 | 0 | 0 | 0 | 0 | 0 | 0 |
| CE1 | 2.5 | 0 | 2.5 | 94.0 | 1.0 | 0 | 0 | 0 | 0 | 0 | 0 | 0 | 0 | 0 |
| CE2 | 2.5 | 0 | 2.5 | 90.0 | 5.0 | 0 | 0 | 0 | 0 | 0 | 0 | 0 | 0 | 0 |
| EX4 | 2.5 | 0 | 2.5 | 93.4 | 1.0 | 0 | 0 | 0 | 0.6 | 0 | 0 | 0 | 0 | 0 |
| EX5 | 2.5 | 0 | 2.5 | 93.4 | 1.0 | 0 | 0 | 0 | 0 | 0.6 | 0 | 0 | 0 | 0 |
| EX6 | 2.5 | 0 | 2.5 | 93.4 | 1.0 | 0 | 0 | 0 | 0 | 0 | 0.6 | 0 | 0 | 0 |
| CE3 | 2.5 | 0 | 2.5 | 93.0 | 1.0 | 1.0 | 0 | 0 | 0 | 0 | 0 | 0 | 0 | 0 |
| CE4 | 2.5 | 0 | 2.5 | 93.0 | 1.0 | 0 | 1.0 | 0 | 0 | 0 | 0 | 0 | 0 | 0 |
| CE5 | 2.5 | 0 | 2.5 | 91.5 | 1.0 | 2.5 | 0 | 0 | 0 | 0 | 0 | 0 | 0 | 0 |
| CE6 | 2.5 | 0 | 2.5 | 0 | 0 | 5.0 | 0 | 0 | 0 | 0 | 0 | 0 | 0 | 0 |
| CE7 | 2.5 | 0 | 2.5 | 92.5 | 1.0 | 0 | 0 | 0 | 0 | 0 | 0 | 1.5 | 0 | 0 |
| CE8 | 2.5 | 0 | 2.5 | 92.0 | 1.0 | 0 | 0 | 0 | 0 | 0 | 0 | 0 | 2.0 | 0 |
| CE9 | 2.5 | 0 | 2.5 | 92.4 | 0 | 0 | 0 | 0 | 0.6 | 0 | 0 | 0 | 2.0 | 0 |
| EX7 | 2.5 | 0 | 2.5 | 89.4 | 5.0 | 0 | 0 | 0 | 0.6 | 0 | 0 | 0 | 0 | 0 |
| EX8 | 0.5 | 0 | 0.5 | 97.4 | 1.0 | 0 | 0 | 0 | 0.6 | 0 | 0 | 0 | 0 | 0 |
| EX9 | 1.0 | 0 | 1.0 | 96.4 | 1.0 | 0 | 0 | 0 | 0.6 | 0 | 0 | 0 | 0 | 0 |
| EX10 | 1.5 | 0 | 1.5 | 95.4 | 1.0 | 0 | 0 | 0 | 0.6 | 0 | 0 | 0 | 0 | 0 |
| EX11 | 2.0 | 0 | 2.0 | 94.6 | 1.0 | 0 | 0 | 0 | 0.6 | 0 | 0 | 0 | 0 | 0 |
| CE10 | 2.5 | 0 | 2.5 | 93.5 | 1.0 | 0 | 0 | 0 | 0 | 0 | 0 | 0 | 0 | 0.5 |
| EX12 | 0 | 2.0 | 2.0 | 94.7 | 1.0 | 0 | 0 | 0.3 | 0 | 0 | 0 | 0 | 0 | 0 |
| EX13 | 0 | 2.0 | 2.0 | 90.7 | 5.0 | 0 | 0 | 0.3 | 0 | 0 | 0 | 0 | 0 | 0 |
| EX14 | 0 | 2.0 | 2.0 | 94.6 | 1.0 | 0 | 0 | 0 | 0.6 | 0 | 0 | 0 | 0 | 0 |
| EX15 | 0 | 2.0 | 2.0 | 94.6 | 1.0 | 0 | 0 | 0 | 0 | 0.6 | 0 | 0 | 0 | 0 |
| EX16 | 0 | 1.5 | 1.5 | 95.7 | 1.0 | 0 | 0 | 0.3 | 0 | 0 | 0 | 0 | 0 | 0 |
| EX17 | 0 | 2.0 | 2.0 | 94.7 | 1.0 | 0 | 0 | 0.3 | 0 | 0 | 0 | 0 | 0 | 0 |
| EX18 | 0 | 2.5 | 2.5 | 93.7 | 1.0 | 0 | 0 | 0.3 | 0 | 0 | 0 | 0 | 0 | 0 |

### Comparative Example 11 (CE11)

MB24 underwent tack and haze testing, and the results are represented in Table 4. A substrate without a sample applied was defined as Control.

TABLE 4
Tack and Haze Testing Results

| | Tack (g · mm) | | | | Haze | | | |
|---|---|---|---|---|---|---|---|---|
| | Test | Test | Test | | Test | Test | Test | |
| | 1 | 2 | 3 | Avg | 1 | 2 | 3 | Avg |
| Control | 0 | 0 | 0 | 0 | 0 | 0 | 0 | 0 |
| CE2 | 0.86 | 0.05 | 0.13 | 0.35 | 0.82 | 0.94 | 0.83 | 0.87 |
| EX12 | 5.58 | 0.09 | 0 | 1.89 | 1.26 | 1.25 | 1.37 | 1.29 |
| EX14 | 0.10 | 0.24 | 0.03 | 0.12 | 2.13 | 2.08 | 1.94 | 2.05 |
| CE11 | 0.24 | 72.19 | 46.89 | 39.77 | 3.44 | 7.27 | 11.7 | 7.47 |

Antimicrobial testing was conducted on specific examples and comparative examples, and the results are represented in Table 5.

TABLE 5
Antimicrobial Test Results

Average Log Reduction Value

| | S. aureus | K. pneumoniae |
|---|---|---|
| | (log reduction | (log reduction |
| | value/control | value/control |
| | (no coating)) | (no coating)) |
| EX1 | 4.23/7.38 | 5.25/6.72 |
| EX2 | 3.64/7.38 | 5.25/6.72 |
| EX3 | 3.64/7.38 | 5.25/6.72 |
| CE1 | 2.65/7.27 | NT |
| CE2 | 4.01/7.45 | 5.39/7.03 |
| EX4 | 6.01/7.49 | 5.57/7.99 |
| EX5 | 6.01/7.49 | 5.75/7.99 |
| EX6 | 6.01/7.49 | 6.03/7.99 |
| CE3 | 3.46/7.49 | NT |
| CE4 | 2.25/7.36 | NT |
| CE5 | 3.18/7.36 | NT |
| CE6 | 3.23/7.26 | NT |
| CE7 | 2.26/7.36 | NT |
| CE8 | 1.99/7.36 | NT |
| CE9 | 5.43/7.36 | NT |
| EX7 | 2.98/7.38 | 5.25/6.72 |
| EX8 | 5.84/7.31 | NT |
| EX9 | 5.52/7.31 | NT |
| EX10 | 5.14/7.31 | NT |
| EX11 | 5.02/7.31 | NT |
| CE10 | 0.78/7.04 | 1.89/7.04 |

NT: Not Tested

Residual Self-Sanitization testing was conducted on specific examples and comparative examples, and the results are represented in Table 6.

TABLE 6
Residual Self-Sanitization Test Results

Average Log Reduction Value

| | S. aureus | K. pneumoniae |
|---|---|---|
| | (log reduction | (log reduction |
| | value/control | value/control |
| | (no coating)) | (no coating)) |
| CE1 | 1.32/7.26 | NT |
| EX4 | 5.82/7.29 | 5.38/6.86 |
| EX5 | 5.82/7.29 | NT |
| EX12 | 5.03/7.37 | 5.60/7.07 |
| EX13 | 5.46/7.37 | 5.60/7.07 |
| EX14 | 5.45/7.37 | 5.50/7.07 |
| EX15 | 5.89/7.37 | 5.44/7.07 |
| CE11 | 5.74/7.22 | 5.37/6.84 |

NT: Not Tested

Antimicrobial Wet Testing was conducted on specific examples and comparative examples, and the results are represented in Table 7.

TABLE 7
Antimicrobial Wet Testing Results

Average Log Reduction Value

| | S. aureus | K. pneumoniae |
|---|---|---|
| | (log reduction | (log reduction |
| | value/control | value/control |
| | (no coating)) | (no coating)) |
| EX16 | 5.01/6.19 | 5.94/5.94 |
| EX17 | 4.52/6.19 | 5.94/5.94 |
| EX18 | 4.52/6.19 | 5.94/5.94 |
| CE11 | 6.19/6.19 | 5.94/5.94 |

Although the present invention has been described with reference to preferred embodiments, workers skilled in the art will recognize that changes may be made in form and detail without departing from the spirit and scope of the invention.

What is claimed is:

1. A disinfecting composition comprising:
a glucosamine-based saccharide polymer;
a carboxylic acid;
an amino acid-based cationic surfactant; and
a non-ionic surfactant;
wherein the disinfecting composition comprises a carboxylic acid to glucosamine-based saccharide polymer ratio of at least about 1,
wherein a viscosity of the glucosamine-based saccharide polymer is less than about 50 cps, and
wherein upon drying, the disinfecting composition forms a substantially clear and non-tacky film.

2. The disinfecting composition of claim 1, having a wet log reduction value of up to about 6.

3. The disinfecting composition of claim 1, having a dry log reduction value of between about 3 and about 6.

4. The disinfecting composition of claim 1, wherein the carboxylic acid is one of acetic oxalic, lactic, citric, butyric, and octanoic acid.

5. The disinfecting composition of claim 1, wherein the non-ionic surfactant is a glucoside.

6. The disinfecting composition of claim 1, wherein the glucosamine-based saccharide polymer has a concentration of between about 1.5 wt % and about 3 wt %.

7. The disinfecting composition of claim 6, wherein the glucosamine-based saccharide polymer has a concentration of at least about 1.5 wt %.

8. The disinfecting composition of claim 1, wherein the amino acid-based cationic surfactant is ethyl lauryl arginate.

9. The disinfecting composition of claim 1, wherein the disinfecting composition comprises about equal parts glucosamine-based saccharide polymer and carboxylic acid.

10. The disinfecting composition of claim 1, wherein the disinfecting solution has a pH of under 6.

11. The disinfecting composition of claim 10, wherein the disinfecting solution has a pH of under 5.

12. The disinfecting composition of claim 1, wherein the glucosamine-based saccharide polymer is a chitosan.

13. The disinfecting composition of claim 1, wherein the glucosamine-based saccharide polymer has a deacetylation value above about 80%.

14. The disinfecting composition of claim 13, wherein the glucosamine-based saccharide polymer has a deacetylation value above about 85%.

15. The disinfecting composition of claim 1, wherein the glucosamine-based saccharide polymer as a viscosity of less than about 25 cps.
